(19) United States
(12) Patent Application Publication
(10) Pub. No.: US 2011/0041246 A1
(43) Pub. Date: Feb. 24, 2011

(54) SYSTEMS AND METHODS PROVIDING TEMPERATURE REGULATED CUSHION STRUCTURE

(75) Inventors: Geng Li, Hong Kong (CN); Cho-Yee Joey Chow, Hong Kong (CN)

Correspondence Address: FULBRIGHT & JAWORSKI L.L.P, 2200 ROSS AVENUE, SUITE 2800, DALLAS, TX, 75201-2784, US

(73) Assignee: Hong Kong Applied Science and Technology Research Institute Co., Ltd., Shatin (CN)

(21) Appl. No.: 12/544,558

(22) Filed: Aug. 20, 2009

(51) Int. Cl. A47C 21/04; A47K 13/00; B23P 17/04; H05B 1/02

(52) U.S. Cl. 5/421; 4/237; 29/428; 219/490

(57) ABSTRACT

Systems and methods in which temperature regulated cushioning systems are provided in hygienic, convenient configurations are shown. Embodiments provide heating and cooling to provide temperature regulation adapted for human comfort and/or therapeutic effects. Heating and cooling systems implemented with respect to cushioning systems are configured to provided desired temperature regulation for the cushioning system when in use while facilitating hygienic cleaning of the cushioning system. Cushioning structure is preferably adapted to be low weight and to facilitate desired temperature regulation while providing a structure which passively supports and cushions expected loads. Cushion media utilized according to embodiments is modular, such as may comprise a plurality of smaller blocks adapted to cooperate to form a larger cushioning structure. A frame system is utilized according to embodiments to facilitate a desired cooperative arrangement of individual cushion media components and/or to provide various cushioning structure configurations using the cushion media.

### TECHNICAL FIELD

The invention relates generally to cushion structures, such as for providing support for a human body, and more particularly to temperature regulated cushion structures.

### BACKGROUND OF THE INVENTION

Many different configurations of cushioning apparatuses have been utilized over the years to provide support for human bodies or portions thereof, in various body positions. For example, seat cushions have been widely used to provide support and enhance comfort to the human gluteal muscles when the human body is in a seated position. Similarly, mattresses have seen wide use to provide support and enhanced comfort with respect to the human body when in a prone position. Nevertheless, and despite their wide spread and long standing use, such cushioning apparatuses are not without disadvantage.

Cushioning apparatuses, such typical mattresses utilized in providing cushioned bedding for humans, are often quite large (e.g., 39 inches wide by 75 inches long for a typical twin sized mattress or 76 inches wide by 80 inches long for a typical king sized mattress) and relatively heavy (e.g., 75 pounds for a typical twin sized mattress and 150 pounds for a typical king sized mattress). The materials traditionally used in providing resilient support in the foregoing cushioning apparatuses, such as steel springs, polyurethane foam, dense fibrous material (e.g., cotton or polyester batting) are often itself quite heavy. Moreover, such materials are often difficult to clean or sanitize and present an environment suitable for bacterial and/or pests (e.g., dust mites).

Cushioning apparatuses typically operate to absorb the load from a portion of the human body resting upon a surface of the cushioning apparatus, and thus provide enhanced comfort for the portion of the body resting on the cushioning apparatus. However, such cushioning apparatuses typically present a thermal barrier or impediment, thus presenting a potential for discomfort associated with the temperatures experienced by the portion of the human body resting upon a surface of the cushioning apparatus. Moreover, the human body has a relatively small temperature range experienced at the surface of the skin which is considered comfortable for many activities. For example, a typical human body perceives a relatively small temperature range, such as from 60° F. to 75° F. (approximately 15° C. to 24° C.), as comfortable while sleeping. Accordingly, often an entire room or even an entire dwelling is temperature controlled not only to provide temperatures at a sleeping individual's skin surface within such a range, but also to compensate for the effects of a thermal barrier associated with a mattress upon which an individual is sleeping.

Various attempts have been made to improve the perceived comfort of cushioning apparatuses. Such attempts, however, have heretofore not provided fully adequate temperature regulated cushioning apparatuses.

For example, U.S. Pat. No. 6,826,792 to Lin (the '972 patent) discloses an air mattress device having a temperature regulator coupled to an air mattress member to supply regulated air into the air mattress member. Although perhaps initially providing temperature regulated air to the air mattress, the invention of the '972 patent does not appear to provide continued temperature regulation, as experienced by a user thereof, because once the air mattress member is inflated, the flow of air from the temperature regulator ceases or otherwise substantially decreases. Moreover, the inflatable air mattress structure of the '972 patent, wherein pressurized air is used instead of structural material used in providing resilient support, is unsatisfactory for use in many situations, such as where the mattress is to be bent or otherwise shaped while in use, where punctures may occur (i.e., leakage of the cushioning media), etc. The use of air as a cushioning media in the inflatable air mattress structure of the '972 patent may provide an uncomfortable mattress due to the relatively free migration of air within the bladder and the otherwise “soft” nature of the low air pressure cushioning media. The foregoing air mattress member, although perhaps deflatable and thus relatively portable, is typically not easily cleaned. For example, when deflated the air mattress member is prone to having folds and wrinkles which can obscure dirt and other matter from the cleaning process. When inflated, the air mattress member is bulky and difficult to subject to a cleaning process, and the temperature regulator, which appears to be required to maintain the air mattress member in the inflated state, is at risk of damage itself or injury to cleaning personnel (such as through high voltages).

U.S. Pat. No. 6,546,576 to Lin (the '576 patent) discloses an air ventilated mattress wherein temperature adjusted air is provided from a cooling warming air-delivery control box to the interior of a mattress member and exhausted through ventilation buttons in the surface of the mattress member. The mattress member is a relatively large and heavy mattress structure, having a traditional steel spring structure to provide a resilient cushioning surface. This structure is difficult to clean or sanitize. The ventilation buttons, in addition to providing surface perturbations which are likely to be clearly felt by a user of the mattress, provide point delivery of temperature controlled air. Thus the ventilated mattress of the '576 patent does not provide suitable, even distribution of heating or cooling to a user.

U.S. Pat. No. 5,448,788 to Wu (the '788 patent) discloses a water cooled mattress unit, without the ability to provide heating. The mattress member itself is a relatively large and heavy mattress structure, and the water cooling structure adds significantly to the weight and size of the overall unit. Such size and weight is particularly unaccommodating to cleaning or sterilizing of the mattress. Moreover, the water circulation system presents substantial structure just below a relatively thin mattress surface, and thus is likely be clearly felt by a user of the mattress and/or otherwise affect the cushioning provided by the mattress member. Such a water cooled configuration is unsatisfactory for use in many situations, such as where the mattress is subject to freezing temperatures, where punctures in the water circulation system may occur (i.e., leakage of the cooling media), where the added weight of the water cannot be accommodated. The use of water as a cooling media is particularly troublesome in that the cooling media is susceptible to undesired biological growth, such as algae, without regular and substantial maintenance (e.g., changing the cooling media periodically). Although various biocides may be added to the cooling media to discourage such biological growth, the use of such biocides are generally undesirable where human exposure is likely (e.g., the foregoing leakage risk).

U.S. Pat. No. 4,825,868 to Susa et al. (the '868 patent) discloses a foam mattress member having heating strips disposed in corrugations of the foam mattress member, without the ability to provide cooling. The mattress member is a relatively large and heavy mattress structure, comprising a dense foam material as is common in present day mattresses. This structure is difficult to clean or sanitize. Moreover, there is no convenient and practical way to introduce cooling to the mattress member.

### BRIEF SUMMARY OF THE INVENTION

The present invention is directed to systems and methods in which temperature regulated cushioning systems are provided in hygienic, convenient configurations. Cushioning systems of embodiments of the invention comprise bedding, such as mattresses for use in homes, hospitals, hotels, emergency relief, etc., and seating, such as seat cushions for use in home furnishings, office furnishings, vehicle seats, toilet seats, etc.

Embodiments of the invention provide heating and cooling to provide temperature regulation adapted for human comfort and/or therapeutic effects. Heating and cooling systems implemented with respect to cushioning systems according to embodiments of the invention are configured to provided desired temperature regulation for the cushioning system when in use while facilitating hygienic cleaning of the cushioning system. For example, heating and cooling system components are adapted for cleaning with cushion media of a cushioning system and/or are easily removed from the cushioning system for cleaning of the cushion media. Sources of heat and cooling utilized by embodiments of the invention are adapted for efficiency, such as through use of thermal electric coolers, carbon fiber far infrared (FIR) heat sources, host facility heating, ventilation, and air-conditioning (HVAC) plants, and/or the like.

Cushioning structure utilized in cushioning systems of embodiments of the invention is adapted to be relatively low weight and to facilitate desired temperature regulation with respect to a portion of a human body resting on the cushioning system while providing a structure which passively supports and cushions expected loads (i.e., without the use of active support apparatus, such as air chamber inflation blowers). For example, cushion media of embodiments comprises a medium having a substantially uniform cross-sectional density and which allows temperature regulating energy from heating and cooling systems of the cushioning system to pass substantially unimpeded. Embodiments of the invention utilize a plastic filament bent into substantially random shapes (referred to herein as a filament mesh) to form a rectangular block, or other cushioning structure shape, having a substantially uniform cross-sectional density. The foregoing filament mesh provides appreciable open space between the plastic filament, within the cushioning structure shape, to allow air to pass. Additionally or alternatively, the material from which the plastic filament is formed (e.g., nylon, polyvinylidene fluoride, polyethylene, etc.) is substantially transparent to FIR radiation to allow temperature regulating energy to pass. Embodiments of the invention may utilize natural fibers, such as that of the luffa sponge gourd, or combinations of natural and synthetic fibers.

Cushion media utilized according to embodiments of the invention is preferably adapted to facilitate cleaning and to promote hygiene. For example, the plastic filament of the foregoing filament mesh may be formed of a material (e.g., the aforementioned nylon, polyvinylidene fluoride, polyethylene, etc.) which is water and/or other solvent washable, which is unaffected by sterilizing agents, etc. Moreover, the filament mesh configuration of the foregoing example is well suited to cleaning, drying, and sanitizing procedures and provides a media which is not conducive to pest infiltration and/or habitation. Additionally or alternatively, the material from which the cushion media is formed may be impregnated, or otherwise treated, with antibacterial and/or antimicrobial substances (e.g., alcohols, chlorine, peroxides, aldehydes, etc.).

Cushioning systems provided according to embodiments of the invention are adapted for portability and/or use in various configurations. For example, cushion media utilized according to embodiments is modular, such as may comprise a plurality of smaller blocks adapted to cooperate to form a larger cushioning structure. Accordingly, even a cushioning system as large as a mattress may be easily moved, transported, etc. by moving individual cushion media components and other components (e.g., heating and cooling system components). Such individual cushion media components of embodiments are utilized to provide various cushioning structure configurations, such as to provide a mattress surface which is adjustable (e.g., flat, elevated head portion, elevated leg portion, lowered leg portion, etc.). Moreover, such cushion media components themselves are more easily cleaned and/or sterilized, thus further facilitating cleaning and promoting hygiene with respect to the cushioning system.

Embodiments of the invention utilize a frame system to support e cushioning structure. Such a frame system is utilized according to embodiments to facilitate a desired cooperative arrangement of individual cushion media components and/or to provide various cushioning structure configurations using the cushion media. Frame systems of embodiments are further adapted to facilitate temperature regulation, such as to provide pathways to heating and cooling systems, facilitating the ingress and/or egress of air, etc. Frame systems utilized according to embodiments are adapted to facilitate cleaning and to promote hygiene. For example, a frame system may be comprised of materials (e.g., plastics) which are water and/or other solvent washable, which is unaffected by sterilizing agents, which present smooth surfaces to promote cleaning, which are treated with antibacterial and/or antimicrobial substances, etc.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWING

For a more complete understanding of the present invention, reference is now made to the following descriptions taken in conjunction with the accompanying drawing, in which:

FIG. 1 shows a functional block diagram of a cushioning system adapted according to embodiments of the present invention;

FIG. 2 shows a filament bent to provide a filament mesh cushion media according to embodiments of the invention;

FIG. 3 shows a plurality of individual cushion media components adapted to cooperate to form a larger cushioning structure according to embodiments of the invention;

FIG. 4 shows a cushioning system adapted according to an embodiment of the invention;

FIG. 5A shows a cushioning system adapted according to another embodiment of the invention;

FIG. 5B shows detail with respect to an embodiment of a solid state cooling element as may be utilized according to embodiments of the invention;

FIG. 6A shows a cushioning system adapted according to another embodiment of the invention;

FIG. 6B shows an exemplary configuration of ducts to provide substantially uniform temperature regulation to a cushioning structure according to embodiments of the invention;

FIGS. 7A-7C show a cushioning system adapted according to another embodiment of the invention;

FIG. 7D shows detail with respect to an embodiment of a solid state heating and cooling element as may be utilized according to embodiments of the invention; and

FIGS. 8A and 8B show an embodiment of a cushioning system adapted to provide various configurations.

### DETAILED DESCRIPTION OF THE INVENTION

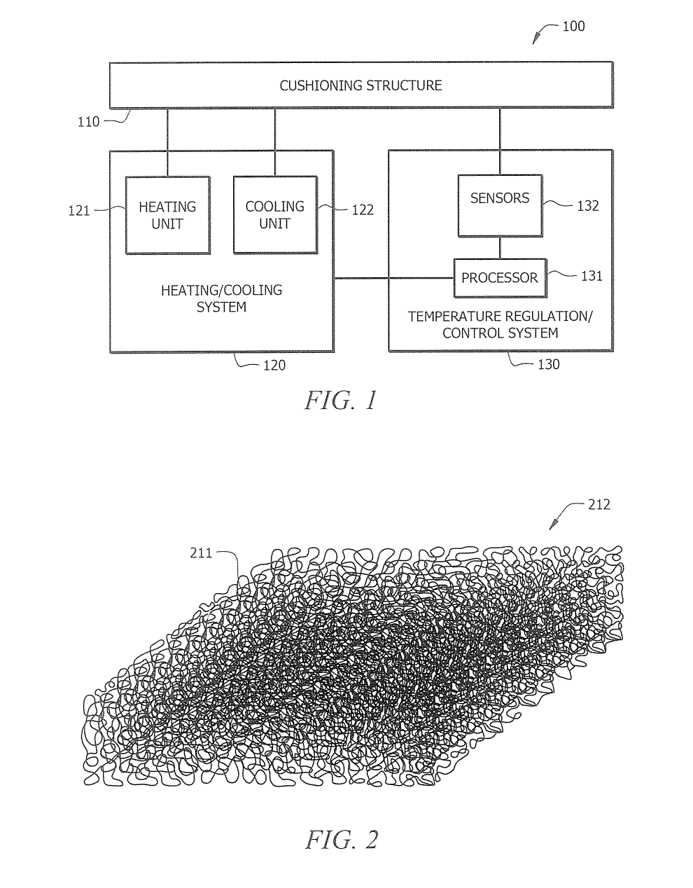

FIG. 1 shows a functional block diagram of cushioning system 100 adapted according to embodiments of the present invention to provide temperature regulated hygienic, convenient configurations. In order to aid in understanding the concepts of the present invention, exemplary embodiments of cushioning system 100 will be described below with reference to mattress configurations. However, it should be appreciated that cushioning system 100 of the illustrated embodiment may comprise bedding, such as mattresses for use in homes, hospitals, hotels, emergency relief, etc., and seating, such as seat cushions for use in home furnishings, office furnishings, vehicle seats, toilet seats, etc.

Cushioning system 100 of the illustrated embodiment comprises three main subsystems. Specifically, the illustrated embodiment of cushioning system 100 comprises cushioning structure 110, heating and cooling system 120, and temperature regulation and control system 130.

Cushioning structure 110 provides one or more surfaces to support and cushion a portion of a body resting thereon. Embodiments of cushioning structure 110 provides a structure which passively supports and cushions expected loads (i.e., without the use of active support apparatus, such as air chamber inflation blowers). Accordingly, cushioning structure 110 preferably provides a resilient structure which is self-supportive of surfaces thereof receiving expected loads. For example, cushion media of embodiments comprises a media having a substantially uniform cross-sectional density to provide an internal structure which is resilient and provides cushioning support to load bearing surfaces. Cushioning structure 110 implemented according to alternative embodiments of the invention may, however, utilize active support apparatus, such as one or more air chamber inflation blower.

To facilitate temperature regulation operation of cushioning system 100, cushioning structure 110 is preferably adapted to allow temperature regulating energy from heating and cooling systems of the cushioning system to pass substantially unimpeded to a user thereof. For example, embodiments of cushioning structure 110 may comprise air ducts, cavities for housing heating and cooling system components, thermal insulation, vents, media which is permeable to air, media which is transparent to particular energy, etc.

Embodiments of the invention utilize a cushion media formed from one or more plastic (e.g., nylon, polyvinylidene fluoride, polyethylene, etc.) filament bent into substantially random shapes (referred to herein as a filament mesh) to form a desired cushioning structure shape. Embodiments of the invention may utilize natural fibers, such as that of the luffa sponge gourd, or combinations of natural and synthetic fibers. Exemplary filament 211 is shown bent into filament mesh 212 according to embodiments of the invention in FIG. 2. Filaments such as filament 211 may be formed through an extrusion process, using various surfaces and manipulators to bend the extruded filament and to provide a desired shape to the resulting filament mesh. Such a filament mesh may be utilized to provide a cushion medium having a substantially uniform cross-sectional density and thus provide cushioning structure as described herein. The foregoing filament mesh also provides appreciable open space between the plastic filament, within the cushioning structure shape, to allow air to pass substantially unimpeded (e.g., air is able to flow through the media by convective/radiant and forced means). Additionally or alternatively, the preferred embodiment plastics from which the filament mesh is formed is substantially transparent to FIR radiation to allow temperature regulating energy to pass. Cushion media formed from a filament mesh as may be adapted to provide cushioning structure as described herein is available from A-Fontane Group Limited, Hong Kong.

Cushion media utilized according to embodiments of the invention is preferably adapted to facilitate cleaning and to promote hygiene. For example, the plastic filament of the foregoing filament mesh may be formed of a material (e.g., the aforementioned nylon, polyvinylidene fluoride, polyethylene, etc.) which is water and/or other solvent washable, which is unaffected by sterilizing agents, etc. Moreover, the filament mesh configuration of the foregoing example is well suited to cleaning, drying, and sanitizing procedures and provides a media which is not conducive to pest infiltration and/or habitation. Additionally or alternatively, the material from which the cushion media is formed may be impregnated, or otherwise treated, with antibacterial and/or antimicrobial substances (e.g., alcohols, chlorine, peroxides, aldehydes, etc.).

Cushioning structure 110 of embodiments is preferably relatively low weight and/or is otherwise adapted to facilitate its portability, handling, movement, cleaning, etc. The use of filament mesh cushion media as in the embodiments discussed above provides a cushioning structure which is reduced in weight over traditional cushioning media (e.g., a weight of approximately 50% that of traditional cushion media). Relatively large cushioning structures, such as those of a mattress embodiment, may nevertheless be appreciably heavy and/or bulky, or otherwise present difficulties with respect to handling, moving, etc.

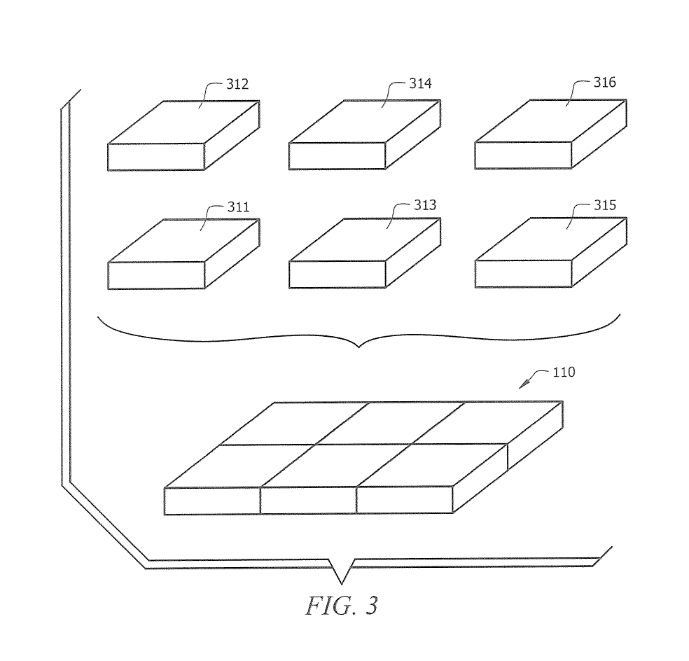

Accordingly, cushion media utilized in providing cushioning structure 110 according to embodiments is modular. For example, the cushion media may comprise a plurality of smaller blocks (e.g., individual cushion media components 311-316) adapted to cooperate to form a larger cushioning structure (e.g., cushioning structure 110), as shown in FIG. 3. Accordingly, even a cushioning system as large as a mattress may be easily moved, transported, etc. by moving individual cushion media components and other components (e.g., heating and cooling system components). Such cushion media components themselves are more easily cleaned and/or sterilized, thus further facilitating cleaning and promoting hygiene with respect to cushioning system 100.

Heating and cooling system 120 facilitates temperature regulation as provided by cushioning system 100 adapted for human comfort and/or therapeutic effects. Heating and cooling system 120 implemented according to embodiments of the invention is configured to provided desired temperature regulation for cushioning system 100 when in use while facilitating hygienic cleaning of the cushioning system. For example, heating and cooling system components are adapted for cleaning with cushion media of cushioning system 100 and/or are easily removed from cushioning system 100 for cleaning of the heating and cooling system and/or cushion media. Moreover, heating and cooling system 120 of embodiments is adapted to efficiently, safely, and effectively provide temperature regulation with respect to cushioning system 100. For example, embodiments of the invention utilize heating and/or cooling unit configurations which operate on relatively low power, direct current power sources. Heating and/or cooling unit configurations of embodiments utilize efficient thermal transfer means, such as may be provided by thermal electric units, heat pump technology, advanced materials technology (e.g., nanotechnology based materials, composites, carbon fiber, etc.), and/or the like. Heating and cooling system 120 of embodiments is adapted to provide temperature regulation uniformly with respect to a user, provide a desired temperature gradient with respect to an area for which temperature regulation is provided, provide precise temperature regulation with respect to one or more areas, etc. (e.g., undesired hot spots/cold spots do not result).

Temperature regulation and control system 130 provides control with respect to heating and cooling system 120 for providing temperature regulation for cushioning system 100. Accordingly, the illustrated embodiment of temperature regulation and control system 130 comprises processor based system 131, such as may comprise one or more processing units (e.g., central processing unit (CPU), application specific integrated circuit (ASIC), programmable gate array (PGA), etc.) having memory (e.g., random access memory (RAM), read only memory ROM), flash memory, etc.) and suitable input/output interfacing (e.g., expansion bus, control bus, inter-integrated circuit (I²C) bus, universal serial bus (USB), etc.) associated therewith and operable under control of an instruction set (e.g., software, firmware, etc.) to provide operation as described herein. One or more sensors 132, such as may comprise thermocouples, thermistors, thermal resistive sensors (RTDs), infrared sensors, etc., may be deployed in, on, or near cushioning structure 110, heating unit 121, and/or cooling unit 122 to provide information utilized by processor 131 in providing control of heating and cooling system 120. Such sensors may be adapted to withstand cleaning solvents and/or may be removable to facilitate cleaning of cushioning structure 110 and/or the sensors according to embodiments of the invention.

Embodiments of heating and cooling system 120 and temperature regulation and control system 130 may be disposed within cushion media of cushioning structure 110 or external thereto. For example, thermal elements (e.g., solid state heating and cooling elements) of heating and cooling system 120 and temperature regulation and control system 130 may be disposed within one or more cavities in cushioning structure 110. Such an embodiment provides an embedded, self-contained cushioning system configuration. Alternatively, heating and cooling system 120 and temperature regulation and control system 130 may be disposed external to cushioning structure 110, such as in a centralized heating and cooling system configuration. Embodiments may dispose either of heating and cooling system 120 and temperature regulation and control system 130, or portions thereof, within cushioning structure 110 and the other system, or portions thereof, external to cushioning structure 110, as desired.

As can be appreciated from the foregoing, embodiments of the present invention provide for temperature regulation as experienced by a user thereof without requiring heating and/or cooling of a larger surrounding volume (e.g., dwelling or room). Moreover, components of embodiments of the temperature regulation system are removable and/or washable and waterproof to facilitate sanitary cleaning of the system and its components. Safe operation is provided according to embodiments of the invention through the use of relatively low voltage and/or direct current thermal control elements, such as carbon fiber FIR heating elements, thermoelectric elements, etc.

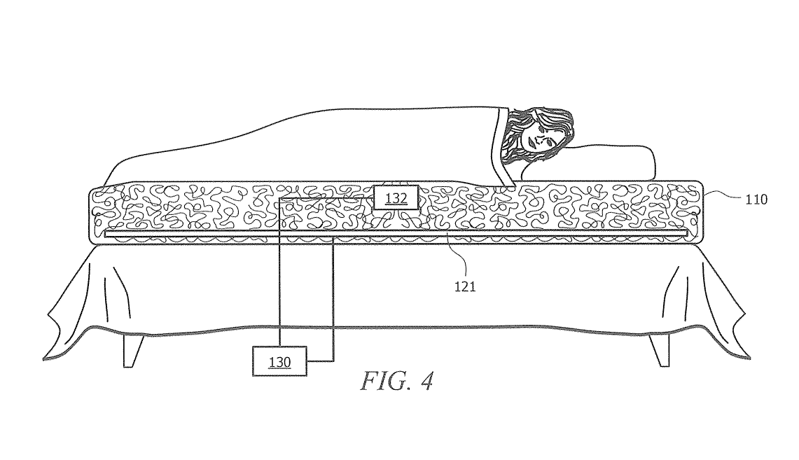

Directing attention to FIG. 4, cushioning system 100 is shown having a configuration of heating unit 121 adapted to provide heat energy according to embodiments of the invention. It should be appreciated that heating unit 121 of embodiments is to be provided in combination with corresponding cooling unit 122, although no such cooling unit is illustrated in FIG. 4 in order to simplify the drawing. Of course, heating unit 121 may be utilized without corresponding cooling unit 122 in alternative embodiments, if desired.

Heating unit 121 of the embodiment illustrated in FIG. 4 comprises one or more planar or sheet like heating element, disposed under or within cushioning structure 110, for radiating heat energy through the cushion media to a user of cushioning system 100. One or more sensors 132 may be disposed on or within cushioning structure 110 for use with respect to temperature regulation and control system 130 providing control of heating unit 121. For example, one or more infrared sensor may be disposed within cushioning structure 110, such as at or near the surface thereof, to sense the temperature of the body of a user of cushioning system 100. Additionally or alternatively, one or more infrared radiation heat sensor may be disposed within cushioning structure 110, such as at or near the surface thereof, to sense the ambient temperature near the surface of cushioning structure 110. Algorithms of an instruction set of processor unit 131 may utilize information from such sensors to control heating unit 121 to regulate the temperature experienced by a user of cushioning system 100.

Sheet like heating elements of the illustrated embodiment may be appropriately sized and shaped to deliver substantially uniform temperature regulation with respect to a user of cushioning system 100 and/or to deliver precise temperature regulation with respect to one or more areas of cushioning system 100. Likewise, sheet like heating elements of the illustrated embodiment may be configured, such as through the use of different heat element densities and/or the zoned control of power through areas of the heating elements, to provide a desired temperature gradient with respect to an area of cushioning system 100. One or more sensors 132, disposed at appropriate locations, may be utilized by temperature regulation and control system 130 in controlling heating and cooling system 120 to provide the foregoing temperature regulation. Materials that may be used for heating unit 121 of various embodiments include carbon fiber heating elements, nano thickness heating elements, thermoelectric heating elements, ceramic heating elements, etc.

Carbon fiber FIR heating elements provide a preferred embodiment of heating unit 121 because the elements may be made into a sheet or sheets of almost any size and shape to provide widespread, even delivery of heat energy, are soft, foldable, machine washable, and thin in thickness. Moreover, delivery of FIR heat energy to a user of cushioning system 100 is efficient and provides therapeutic benefits. For example, FIR heat energy may be generated using relatively low power, direct current energy sources. Moreover, plastic material of preferred embodiment cushion media, as well as textile materials of bedding sheets or other cushion coverings, are substantially transparent to FIR heat energy (i.e., FIR heat energy is primarily absorbed only by water molecules), allowing efficient transmission of heat energy from heating unit 121 to a user of cushioning system 100. FIR heat energy is approximately 90% in 3μ˜15 μm wavelength, which is close to human cells' vibration and thus delivers deep, therapeutic heating to human soft tissue (e.g., skin, muscle, etc.). Such FIR heat energy improves micro circulation by exerting strong rotational and vibrational effects at a molecular level, enhances the delivery of oxygen and nutrients in the blood cells to the body's soft tissue, promotes regeneration and improved healing, increases metabolism, enhances white blood cell function, improves lymph circulation, and stimulates the hypothalamus.

Like carbon fiber FIR heating elements, nano thickness heating elements may be made into a sheet or sheets of almost any size and shape to provide widespread and even delivery of heat energy. Moreover, generation of heat energy by such nano thickness heating elements is efficient. For example, heat energy may be generated using relatively low power, direct current energy sources. Nano thickness heating element material used for heating unit 121 according to an exemplary embodiment comprises a multilayered nano thickness coating material which includes tin, tungsten, titanium and vanadium with organometallic precursors like Monobutyl Tin Tri-chloride doped with equal quantities of donor and acceptor elements preferably antimony and zinc at about 3 mol % deposited over insulating coating layers. Nano thickness heating element material as may be adapted for use according to embodiments of the present invention is available as the NANOHEAT™ product from Advanced Materials Enterprises Company Ltd., Hong Kong. Additional information regarding such nano thickness heating elements is provided in U.S. patent application Ser. No. 12/026,724 filed Feb. 6, 2008 and U.S. provisional patent applications Ser. No. 60/900,994 filed on Feb. 13, 2007 and Ser. No. 60/990,619 filed on Nov. 28, 2007, the disclosures of which are hereby incorporated herein by reference.

The foregoing planar or sheet like heating elements of heating unit 121, disposed under or within cushioning structure 110, facilitate hygienic cleaning of the cushioning system. For example, a sheet like heating element disposed under cushioning structure 110 may be easily cleaned when cushion media is removed for cleaning. A sheet like heating element disposed within cushioning structure 110 may be cleaned with the cushion media, particularly in the case of the foregoing heating element configurations due to their flexibility and tolerance of cleaning solvents.

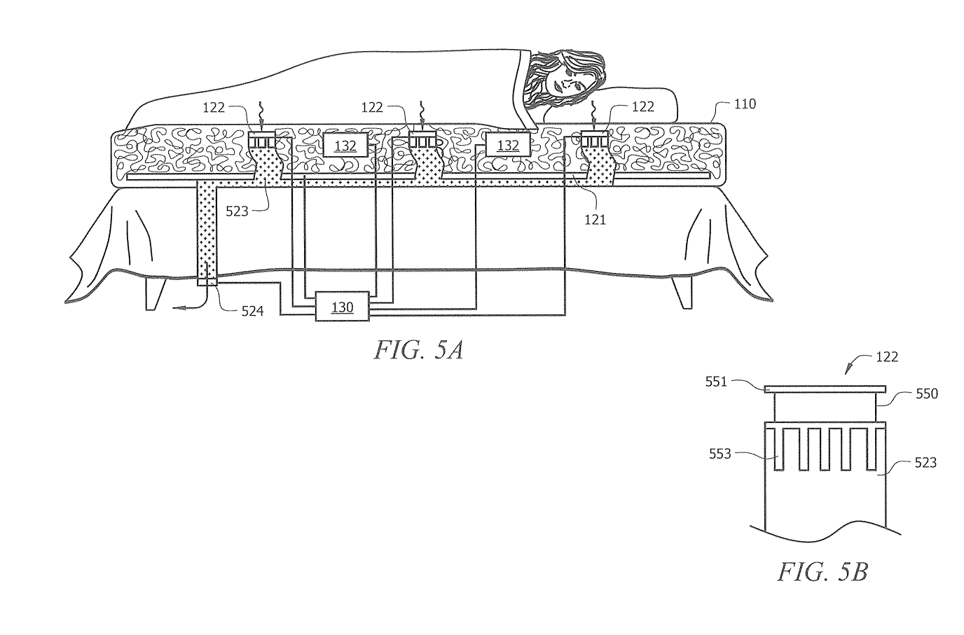

Directing attention to FIG. 5A, cushioning system 100 is shown having a configuration of cooling unit 122 adapted to provide removal of heat energy (cooling) according to embodiments of the invention. It should be appreciated that cooling unit 122 of the illustrated embodiment is provided in combination with corresponding heating unit 121, wherein heating unit 121 may comprise various configurations of heating units. Of course, cooling unit 122 may be utilized without corresponding heating unit 121 in alternative embodiments, if desired.

Cooling unit 122 of the embodiment illustrated in FIG. 5A comprises one or more solid state cooling element, disposed under or within cushioning structure 110, for extracting heat energy from a user of cushioning system 100 through the cushion media. Such an embedded temperature regulation system provides for a convenient, compact cushioning system. One or more sensors 132 may be disposed on or within cushioning structure 110 for use with respect to temperature regulation and control system 130 providing control of cooling unit 122. For example, one or more infrared sensor may be disposed within cushioning structure 110, such as at or near the surface thereof, to sense the temperature of the body of a user of cushioning system 100. Additionally or alternatively, one or more temperature sensor may be disposed within cushioning structure 110, such as at or near the surface thereof, to sense the ambient temperature near the surface of cushioning structure 110. Algorithms of an instruction set of processor unit 131 may utilize information from such sensors to control cooling unit 122 to regulate the temperature experienced by a user of cushioning system 100.

Solid state cooling elements of the illustrated embodiment may be appropriately sized and spaced to deliver substantially uniform temperature regulation with respect to a user of cushioning system 100 and/or to deliver precise temperature regulation with respect to one or more areas of cushioning system 100. Likewise, solid state cooling elements of the illustrated embodiment may be configured, such as through the use of different heat transfer characteristics and/or the zoned control of power through areas of the cooling elements, to provide a desired temperature gradient with respect to an area of cushioning system 100. One or more sensors 132, disposed at appropriate locations, may be utilized by temperature regulation and control system 130 in controlling heating and cooling system 120 to provide the foregoing temperature regulation. Materials that may be used for solid state cooling elements of cooling unit 121 to provide thermoelectric cooling according to various embodiments include bismuth telluride, piezoelectric crystal, etc.

Solid state cooling elements provide a preferred embodiment of cooling unit 122 because the elements may be in almost any size, provide quiet operation, and operate using safe low power direct current. Detail with respect to an embodiment of a solid state cooling element as may be utilized according to embodiments of the invention is shown in FIG. 5B. Specifically, the solid state cooling element configuration of cooling unit 122 shown in FIG. 5B comprises thermoelectric module 550, such as may comprise the aforementioned bismuth telluride, piezoelectric crystal, etc., sandwiched between cooler plate 551 and heat sink 553. When a voltage is applied across thermoelectric module 550, solid state active heat pump operation transfers heat from cooler plate 551 to heat sink 553.

The resulting heat is removed from cushioning structure 110 through ducts 523 in the illustrated embodiment. For example, ducts 523 may comprise various forms of flexible tubing, such as SCAT wire-support tubing, insulated flexible ducts, etc, disposed to capture heat radiated by heat sink 553 and direct the heat away from cushioning system 100. The embodiment illustrated in FIG. 5A includes exhaust fan 524 in communication with ducts 523 and operable under control of temperature regulation and control system 130 to encourage the migration of heat away from cushioning system 100. It should be appreciated that the “breathable” nature of the preferred embodiment cushion media not only facilitates exchange of heat energy to provide temperature regulation with respect to a user of cushioning system 100, but also provides a source of airflow to provide the aforementioned exhausting of resulting heat.

A plurality of solid state cooling elements (i.e., a distributed cooling unit configuration) may be spaced within cushioning structure 110 to provide widespread, even extraction of heat energy (cooling). For example, cavities or pockets may be made within the cushion media of cushioning structure 110 to receive and hold individual solid state cooling elements of an embodiment of cooling unit 121 in desired locations and positions, such as beneath the surface of cushioning structure 110 and spaced to deliver substantially uniform temperature regulation with respect to a user of cushioning system 100 and/or to deliver precise temperature regulation with respect to one or more areas of cushioning system 100 etc. Such cavities or pockets are preferably adapted to removably receive cooling elements to facilitate removal of the cooling elements during cleaning of the cushion media and their replacement thereafter. Embodiments of the invention utilize channels in the cushion media which provide a pathway for the aforementioned ducts (ducts 523) to facilitate insertion and removal of cooling elements within cushioning structure 110.

Although the use of solid state cooling elements have been described above with respect to an embodiment of cooling unit 122, embodiments of the invention may utilize such solid state devices to provide heating. For example, the operation of the aforementioned solid state cooling elements may be reversed (e.g., by physically reversing the elements within cushioning structure 110 or by reversing the voltage applied thereto in operation) to provide delivery of heat energy to a user of cushioning system 100. The use of such solid state thermoelectric heating may be in addition to or in the alternative to FIR heat energy delivered as discussed above.

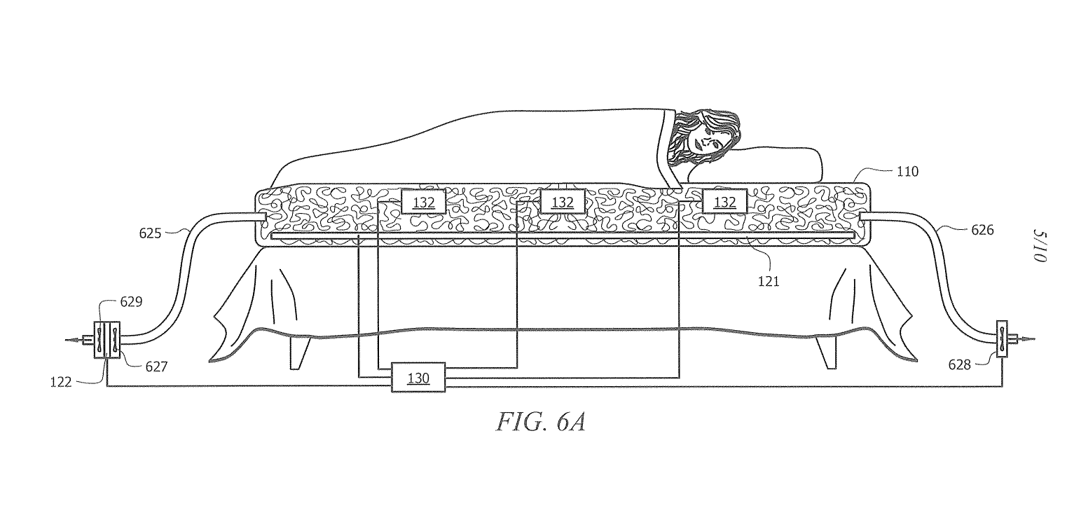

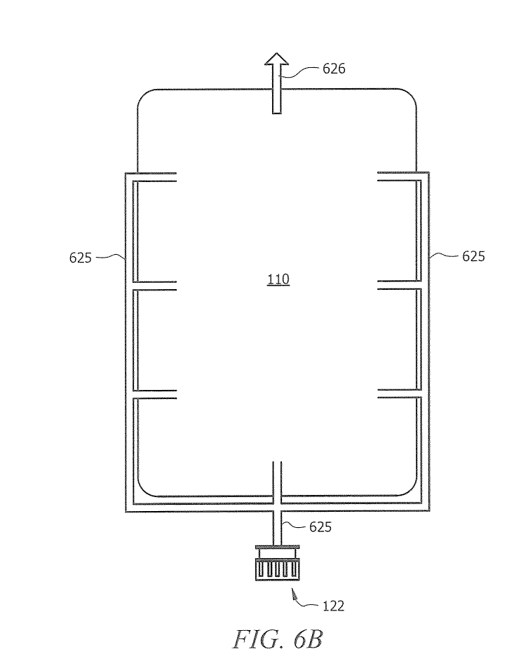

Referring now to FIG. 6A, cushioning system 100 is shown having an alternative configuration of cooling unit 122 according to embodiments of the invention. Cooling unit 122 of the embodiment illustrated in FIG. 6A provides a centralized cooling unit configuration adapted to provide removal of heat energy (cooling) according to embodiments of the invention. It should be appreciated that cooling unit 122 of the illustrated embodiment is provided in combination with corresponding heating unit 121, wherein heating unit 121 may comprise various configurations of heating units. Of course, cooling unit 122 of this embodiment may be utilized without corresponding heating unit 121 in alternative embodiments, if desired.

Cooling unit 122 of the embodiment illustrated in FIG. 6A comprises one or more cooling element, such as may comprise solid state cooling elements, compression cycle cooling elements, absorption cooling elements, etc., disposed in a centralized location, such as external to cushioning structure 110, for delivering temperature regulated air to cushioning structure 110. One or more sensors 132 may be disposed on or within cushioning structure 110 for use with respect to temperature regulation and control system 130 providing control of cooling unit 122. For example, one or more infrared sensor may be disposed within cushioning structure 110, such as at or near the surface thereof, to sense the temperature of the body of a user of cushioning system 100. Additionally or alternatively, one or more temperature sensor may be disposed within cushioning structure 110, such as at or near the surface thereof, to sense the ambient temperature near the surface of cushioning structure 110. Algorithms of an instruction set of processor unit 131 may utilize information from such sensors to control cooling unit 122 to regulate the temperature experienced by a user of cushioning system 100.

Temperature regulated air provided by cooling unit 122 of the illustrated embodiment is delivered to cushioning structure 110 using ducts 625. Ducts 625 may, for example, comprise various forms of flexible tubing, such as SCAT wire-support tubing, insulated flexible ducts, etc. Fan 627, or other means for providing movement of cooled air, may be included to encourage the movement of cooled air from cooling unit 122 to cushioning structure 110. The illustrated embodiment additionally or alternatively includes an exhaust fan disposed to capture heat radiated by cooling elements of cooling unit 122 and direct the heat away from cooling unit 122 and cushioning system 100. Specifically, the embodiment illustrated in FIG. 6A includes exhaust fan 629 operable under control of temperature regulation and control system 130 to encourage the migration of heat away from cushioning system 100.

A cooling element or elements of cooling unit 122 is preferably appropriately sized and corresponding ducts 625 appropriately sized and arranged to deliver substantially uniform temperature regulation with respect to a user of cushioning system 100 and/or to deliver precise temperature regulation with respect to one or more areas of cushioning system 100. Likewise, cooling elements and ducts may be configured to provide a desired temperature gradient with respect to an area of cushioning system 100. It should be appreciated that the “breathable” nature of the preferred embodiment cushion media facilitates exchange of heat energy to provide temperature regulation through delivery of temperature regulated air from cooling unit 122 of the illustrated embodiment.

FIG. 6B shows an exemplary configuration of ducts 625 to provide substantially uniform temperature regulation. Specifically, as seen in the plan view of cushioning structure 110 in FIG. 6B, multiple outlets of ducts 625 may be positioned to provide substantially uniform delivery of temperature regulated air within cushioning structure 110. Alternative embodiments may provide different distributions of temperature regulated air, such as to provide the aforementioned temperature gradient, through altering the number, sizes, and/or placement of various ones of the duct outlets. One or more sensors 132, disposed at appropriate locations, may be utilized by temperature regulation and control system 130 in controlling heating and cooling system 120 to provide the foregoing temperature regulation.

Heating and cooling system 120 of the embodiment illustrated in FIG. 6A includes air flow fan 628 and corresponding duct 626. Air flow fan 628 is included according to embodiments of the invention to encourage the flow of temperature regulated air from cooling unit 122 within cushioning structure 110. Not only does such air flow assist in improving the efficiency of cooling unit 122, but it facilitates more uniform or complete temperature regulation for cushioning system 100 according to embodiments of the invention.

The particular technology utilized for cooling elements of cooling unit 122 of the embodiment of FIG. 6A may be selected to satisfy any of a number of criteria, such as energy efficiency, size, cost, quite operation, etc. Embodiments may, for example, utilize one or more solid state cooling elements because the elements may be in almost any size, provide quiet operation, and operate using safe low power direct current. Other embodiments may utilize a compressor cycle cooling element (e.g., Freon gas compression/expansion refrigeration unit) because such a cooling element provides rapid cooling of relatively large volumes of air. Although such compressor cycle cooling elements do not typically operate as quietly as some other forms of cooling elements (e.g., solid state cooling elements), the centralized configuration of the embodiment of FIG. 6A facilitates the placement of such components of cooling unit 122 away from cushioning structure 110, and thus may mitigate any undesired noise.

The centralized configuration of the embodiment of FIG. 6A further facilitates removal of the cooling elements during cleaning of the cushion media and their replacement thereafter. Specifically, because cooling elements of cooling unit 122 may be disposed external to cushioning structure 110, the cooling elements may be readily removed for cleaning of the cushion media.

Moreover, the centralized configuration of the embodiment of FIG. 6A facilitates leveraging cooling elements available from other systems. For example, rather than a stand-alone cooling element for use with respect to cushioning system 100, embodiments of the invention may couple ducts 625 to a host facility (e.g., home, office, etc.) HVAC system to receive temperature regulated air, or other media, therefrom (i.e., cooling system 122 of such an embodiment comprises at least a portion of the host facility HVAC system). As one example, a host facility HVAC system may be adapted to provide zoned output of heating and/or cooling, and temperature regulation and control system 130 may be interfaced with the HVAC system to utilize output from the HVAC system to provide the foregoing temperature regulation with respect to cushioning system 100.

Although the use of centralized cooling elements have been described above with respect to an embodiment of cooling unit 122, embodiments of the invention may utilize such embodiments to provide heating. For example, the operation of the aforementioned cooling elements may be reversed or the foregoing cooling elements may be replaced with heating elements to provide delivery of heat energy to a user of cushioning system 100. The use of such heating may be in addition to or in the alternative to FIR heat energy delivered as discussed above.

It should be appreciated that cushioning system 100 of the foregoing embodiments may be utilized to absorb the load from a portion of the human body resting upon a surface of cushioning structure 110, and thus provide comfort for the portion of the body resting on the cushioning apparatus. Moreover, temperature regulation provided through operation of heating and cooling system 120 and temperature regulation and control system 130, in cooperation with adaptation of cushioning structure 110 to facilitate exchange of heat energy as described herein, enhances the comfort associated with the temperatures experienced by the portion of the human body resting upon a surface of cushioning structure 110. Because the human body has a relatively small temperature range experienced at the surface of the skin which is considered comfortable for many activities, cushioning systems of the present invention are uniquely adapted to provide comfort to users thereof. Accordingly, an entire room or even an entire dwelling need not be temperature controlled while embodiments of the invention provide temperature regulation sufficient to maintain a user's skin surface within a comfort range. Moreover, embodiments of cushioning systems of the present invention are adapted to provide therapeutic benefits, such as through delivery of the aforementioned FIR heat energy.

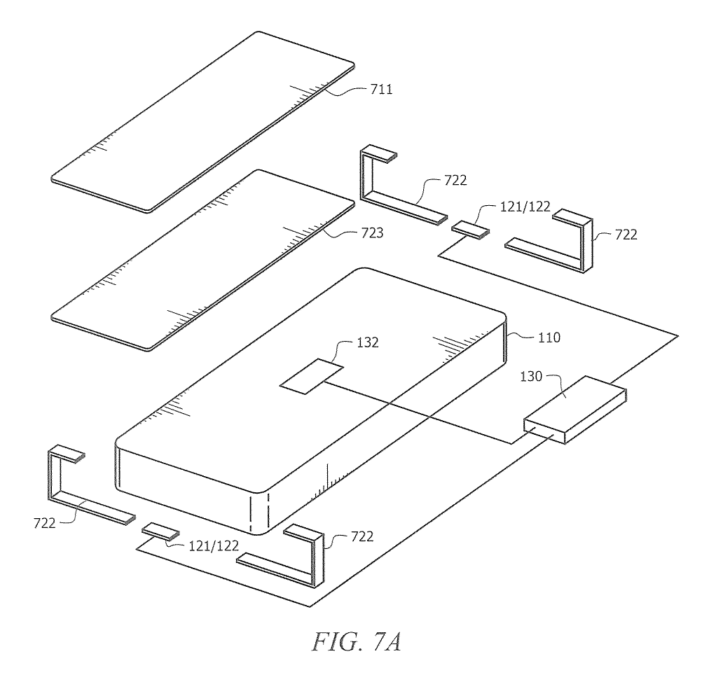

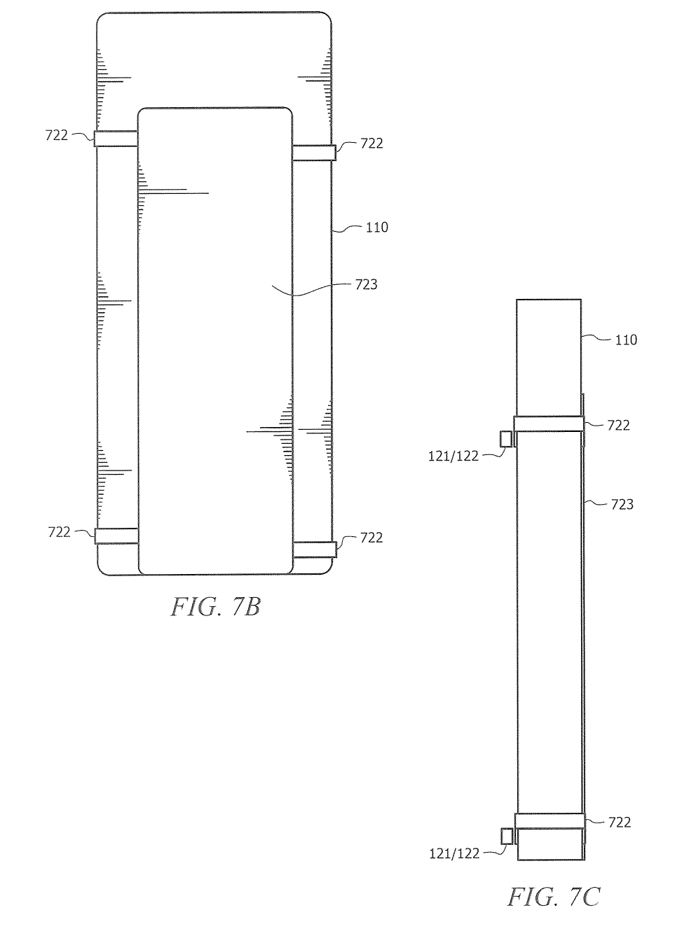

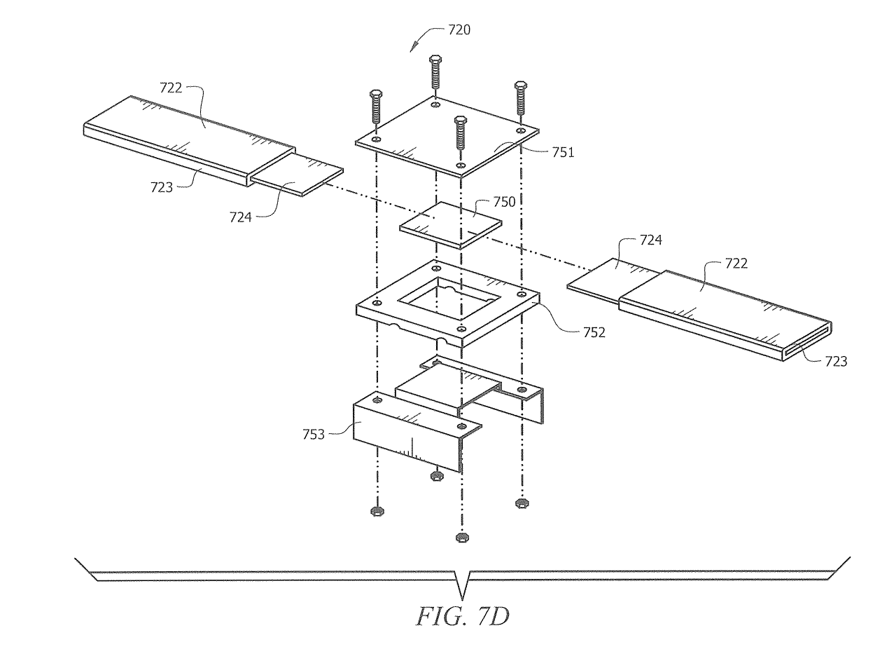

Directing attention to FIGS. 7A-7C, cushioning system 100 is shown having an integrated configuration of heating unit 121 and cooling unit 122 adapted to provide both radiating heat energy and removal of heat energy (cooling) according to embodiments of the invention. It should be appreciated that although the illustrated embodiment shows an integrated configuration of heating unit 121 and cooling unit 122, embodiments of heating unit 121 and cooling unit 122 may be provided separately, even using different heating/cooling technologies, in an arrangement otherwise as shown in FIGS. 7A-7C, if desired.

Heating unit 121/cooling unit 122 of the embodiment illustrated in FIGS. 7A-7C comprises one or more solid state temperature control element, disposed under or within cushioning structure 110, for delivering heat energy to and extracting heat energy from a user of cushioning system 100 through thermal sheet 723. Thermal sheet 723 of embodiments is adapted to provide high thermal conductivity and emit FIR heat energy. Accordingly, thermal sheet 723 is disposed on or near (e.g., just beneath) a surface of cushioning structure 110 which supports a user thereof. Thermal conductors 722 and cushioning structure 110 are provided in the illustrated embodiment to provide communication of thermal energy between heating unit 121/cooling unit 122 and thermal sheet 723. Such a temperature regulation system provides a configuration which may readily be adapted for use with conventional or existing cushioning structures, such as conventional mattresses. Of course, the temperature regulation system of the embodiment shown in FIGS. 7A-7C may be utilized with respect to other cushioning structures, such as that formed from the cushion medium of FIG. 2.

Similar to the embodiments discussed above, one or more sensor 132 may be disposed on or within cushioning structure 110 for use with respect to temperature regulation and control system 130 providing control of heating unit 121/cooling unit 122. For example, one or more temperature sensor may be disposed within cushioning structure 110, such as at or near the surface thereof, to sense the temperature of the body of a user of cushioning system 100. Additionally, or alternatively, one or more temperature sensor may be disposed within cushioning structure 110, such as at or near the surface thereof, to sense the ambient temperature near the surface of cushioning structure 110. Embodiments of the invention may dispose one or more sensor 132 on or near components of the temperature regulation system, such as on or within thermal sheet 723, to sense the temperature of the body of a user of cushioning system 100 and/or to sense the temperature of such temperature regulation system components. Algorithms of an instruction set of processor unit 131 may utilize information from such sensors to control heating unit 121/cooling unit 122 to regulate the temperature experienced by a user of cushioning system 100.

Thermal sheet 723 of embodiments of the invention comprises a sheet, such as may be comprised of a thin, flexible layer of carbon fiber, providing efficient and substantially even conduction and radiation of thermal energy. Accordingly, heat energy may be radiated and/or absorbed by thermal sheet 723 to provide temperature regulation operation according to embodiments of the invention. Protective sheet 711 is provided in the illustrated embodiment to provide a protective, waterproof covering to thermal sheet 723. For example, protective sheet 711 may comprise a flexible, water impermeable or water resistant plastic or polymer which provides suitable thermal conductivity and/or heat energy transparency. Embodiments of protective sheet 711 are comprised of TEFLON (polytetrafluoroethylene), silicon, fabric, and/or the like.

Heat energy radiated by a user laying prone on cushioning system 100 is absorbed by thermal sheet 723 and conducted to thermal conductors 722 according to embodiments of the invention. Thermal conductors 722, which comprise carbon fiber wire suitable for conducting thermal energy according to embodiments, may thus conduct the heat energy collected by thermal sheet 723 to heating unit 121/cooling unit 122. When operating as a cooling unit, heating unit 121/cooling unit 122 may operate to absorb heat conducted from thermal sheet 723 to heating unit 121/cooling unit 122 by thermal conductors 722. The heat absorbed by heating unit 121/cooling unit 122 may thus be transferred to another medium, such as by dissipation of the heat energy from heating unit 121/cooling unit 122 into the surrounding air. Conversely, heat energy radiated by heating unit 121/cooling unit 122, when operating as a heating unit, may be conducted from heating unit 121/cooling unit 122 to thermal sheet 723 by thermal conductors 722. This heat energy may be conducted throughout thermal sheet 723 for transfer to a user lying upon cushioning system 100, such as through radiation from a surface of thermal sheet 723 to the user. Radiation of heat energy by thermal sheet 723 is preferably provided as FIR radiant energy, such as may be provided by a carbon fiber embodiment of thermal sheet 723.

Solid state temperature control elements of the illustrated embodiment (e.g., heating unit 121/cooling unit 122) may be appropriately sized and spaced to deliver substantially uniform temperature regulation with respect to a user of cushioning system 100 and/or to deliver precise temperature regulation with respect to one or more areas of cushioning system 100. Likewise, solid state temperature control elements of the illustrated embodiment may be configured, such as through the use of different heat transfer characteristics and/or the zoned control and/or placement of the temperature control elements, to provide a desired temperature gradient with respect to an area of cushioning system 100. One or more sensors 132, disposed at appropriate locations, may be utilized by temperature regulation and control system 130 in controlling heating and cooling system 120 to provide the foregoing temperature regulation. Materials that may be used for solid state cooling elements of cooling unit 121 to provide thermoelectric cooling according to various embodiments include bismuth telluride, piezoelectric crystal, etc.

Solid state temperature control elements provide a preferred embodiment of heating unit 121/cooling unit 122 because the elements may be in almost any size, provide quiet operation, and operate using safe low power direct current. Detail with respect to an embodiment of a solid state temperature control element as may be utilized according to embodiments of the invention is shown in FIG. 7D. Specifically, the solid state temperature control element configuration of heating unit 121/cooling unit 122 shown in FIG. 7D comprises thermoelectric module 750, such as may comprise the aforementioned bismuth telluride, piezoelectric crystal, etc., sandwiched between plate 751 and housing 752. Thermally conductive portions of thermal conductors 724 are disposed in communication with thermoelectric module 750, such as in a compression interface arrangement between thermoelectric module 750 and plate 751. That is, plate 751 and housing 752 of embodiments are used to clip thermoelectric module 750 and thermal conductors 722 together to ensure good contact and thermal transfer. Embodiments of plate 751 and housing 752, which may be comprised of a plastic or other insulating material, are further used to prevent external or atmospheric heat exchange between the different sides (e.g., “hot” side and “cold” side) of thermoelectric module 750.

Embodiments of thermal conductors 722 are covered in insulating material 723, such as may comprise plastic, foam, etc., to avoid heat energy loss between thermoelectric module 750 and thermal sheet 723 (it being appreciated that portions (e.g., portion 724) of thermal conductors 722 actually interfacing with thermoelectric module 750 and/or with thermal sheet 723 may be devoid of such insulating material to facilitate thermal transfer between thermal conductors 722 and thermoelectric module 750 and/or thermal sheet 723). Heat sink 753 is provided in communication with thermoelectric module 750, through housing 752, to provide thermal communication between thermoelectric module 750 and another medium, such as ambient air. When a voltage is applied across thermoelectric module 750, solid state active heat pump operation transfers heat between thermal conductors 722 and heat sink 753, wherein the polarity of the voltage determines the direction of heat energy transfer.

Solid state temperature control elements may be interfaced with thermal sheet 723 in a spaced apart configuration to provide widespread, even delivery/extraction of heat energy (heating/cooling). For example, thermal conductors 722 may be interfaced with thermal sheet 723 in desired locations and positions, such as spaced to deliver substantially uniform temperature regulation with respect to a user of cushioning system 100 and/or to deliver precise temperature regulation with respect to one or more areas of cushioning system 100 etc.

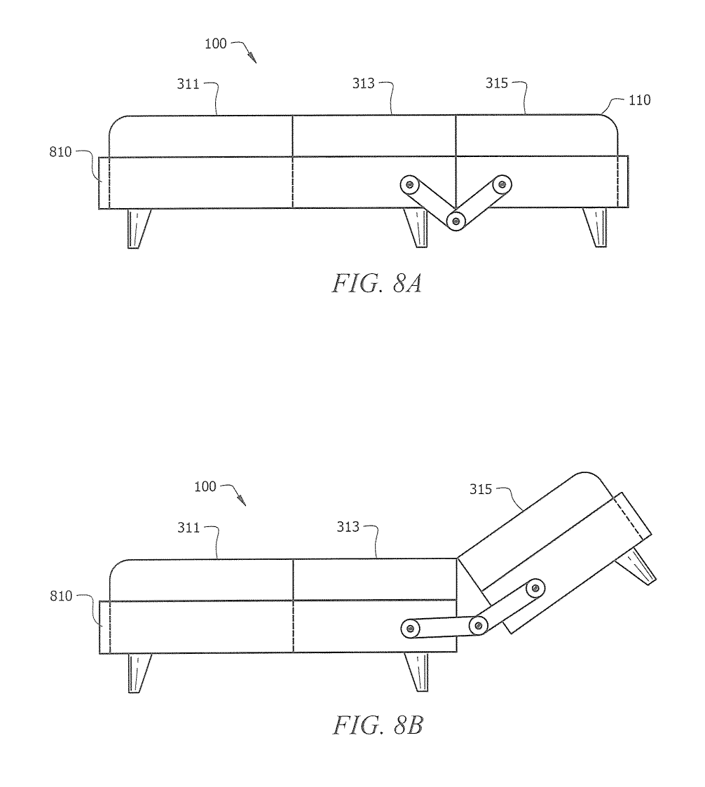

Cushioning systems provided according to embodiments of the invention are adapted for use in various configurations. For example, individual cushion media components (e.g., individual cushion media components 311-316 of FIG. 3) of embodiments are utilized to provide various cushioning structure configurations, such as to provide a mattress surface which is adjustable. Directing attention to FIGS. 8A and 8B, an embodiment of cushioning system 100 is shown adapted to provide various configurations. It should be appreciated that heating and cooling system 120 and temperature regulation and control system 130 are not shown in FIGS. 8A and 8B for simplicity.

FIG. 8A shows cushioning system 100 providing cushioning structure 100 in a flat configuration, such as may be used to accommodate a human body in a prone sleeping position. FIG. 8B shows the embodiment of cushioning system 100 of FIG. 8A disposed in a elevated head portion configuration, such as may be used to accommodate a human body resting is a “sitting-up” position. It should be appreciated that the individual cushion media components facilitate articulation of portions of cushioning structure 110 to provide various configurations. Moreover, such articulation is accomplished substantially without introducing wrinkles or other surface perturbations in cushioning structure 100 associated with folding or otherwise distorting the cushion media (e.g., see the articulated region of FIG. 8B) due to the use of separate cushion media components of embodiments. Embodiments of the invention may utilize expandable/compressible ducting, baffles, surfaces, etc. to maintain desired air flow and/or other communication between individual cushion media components.

Although an embodiment has been illustrated providing a flat configuration and an elevated head portion configuration, embodiments of the present invention may provide configurations in addition to or in the alternative to those illustrated. For example, embodiments of the invention may provide an elevated leg portion configuration, a lowered leg portion configuration, etc.

Embodiments of the invention utilize a frame system to support cushioning structure 110, as represented by frame structure 810 in FIGS. 8A and 8B. Frame system 810 is utilized according to embodiments to facilitate a desired cooperative arrangement of individual cushion media components 311-316. Additionally or alternatively, frame system 810 is utilized to provide various cushioning structure configurations using the cushion media, as illustrated in FIGS. 8A and 8B. Frame system 810 of embodiments is further adapted to facilitate temperature regulation, such as to provide pathways to heating and cooling systems, facilitating the ingress and/or egress of air, etc. Frame system 810 of embodiments is adapted to facilitate cleaning and to promote hygiene. For example, frame system 810 may be comprised of materials (e.g., plastics) which are water and/or other solvent washable, which is unaffected by sterilizing agents, which present smooth surfaces to promote cleaning, which are treated with antibacterial and/or antimicrobial substances, etc.

From the above described embodiments, it can be appreciated that cushioning systems in accordance with concepts of the present invention provide thermally regulated cushioning structures which are readily cleanable which may be maintained in a sanitary manner. Accordingly, cushioning systems of embodiments of the present invention are particularly well suited for use in environments requiring clean, comfortable surfaces, such as in hospitals (e.g., patient beds, birthing beds, surgical table cushions, etc.), hotels (e.g., guest beds, “rollaway” or temporary beds, etc.), and nurseries (e.g., cribs, changing table cushions, etc.). The cushion media of preferred embodiment cushioning systems may be easily cleaned of any foreign matter, such as blood, urine, fecal matter, food particles, etc., by removing some or all heating and cooling system components from the cushioning structure (it being appreciated that components which are tolerant of cleaning solvents used may remain) and exposing the cushion media to a cleaning/sanitization process. Cushion media of embodiments is separable into individual cushion media components to facilitate such cleaning.

Such readily cleanable, temperature regulated cushioning systems have a wide range of applicability. For example, in addition to their use as bedding, cushioning systems of the present invention may be utilized in seating applications. For example, it is often desirable to provide cushioning with respect to toilet seats, particularly for the infirm or elderly. Moreover, communication with plumbing and their being manufactured from materials such as metals or porcelain often results in toilets having uncomfortable seat temperatures. However, hygiene is of utmost concern with respect to toilets and their associated components. Cushioning systems of the present invention provide a cushioning solution which is uniquely well suited for application to toilet seating due to its ability to be cleaned, its safe and effective delivery of heat energy, etc.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A system comprising:
a cushioning structure, the cushioning structure comprised of a cushion media having a substantially uniform cross-sectional density and adapted to allow air to pass substantially unimpeded through the cushion media;
a heating and cooling system in communication with the cushioning structure and providing temperature regulation thereof; and
a temperature regulation and control system in communication with the heating and cooling system and providing control thereof.

2. The system of claim 1, wherein the cushion media comprises a filament mesh.

3. The system of claim 2, wherein a material forming the filament mesh is impregnated with at least one of an antibacterial and an antimicrobial substance.

4. The system of claim 1, wherein the cushioning structure comprises:
a plurality of individual cushion media components formed from the cushion media, wherein the individual cushion media components are adapted to cooperate to form the cushioning structure.

5. The system of claim 4, wherein the individual cushion media components are further adapted to provide various cushioning structure configurations of the cushioning structure.

6. The system of claim 5, wherein the cushioning structure comprises an adjustable mattress

7. The system of claim 4, wherein the cushion media components are adapted for easy cleaning of the cushion media.

8. The system of claim 1, wherein the cushioning structure comprises:
one or more cavities defined in the cushion media into which a thermal element of the heating and cooling system is removably disposed.

9. The system of claim 8, wherein the cushioning structure further comprises:
at least one exhaust port channel defined in the cushion media and coupled to the one or more cavities to facilitate removal of waste radiated by the thermal element.

10. The system of claim 8, wherein the thermal element comprises a cooling element.

11. The system of claim 10, wherein the cooling element comprises a thermoelectric cooling element.

12. The system of claim 8, wherein the thermal element comprises a heating element.

13. The system of claim 12, wherein the heating element comprises a far infrared heating element.

14. The system of claim 1, wherein the cushioning structure comprises a mattress.

15. The system of claim 1, wherein the cushioning structure comprises a seat cushion.

16. The system of claim 1, wherein the cushioning structure comprises a toilet seat.

17. A system comprising:
a cushioning structure comprised of cushion media;
a heating and cooling system in communication with the cushioning structure and providing temperature regulation thereof, thermal elements of the heating and cooling system being disposed within the cushion media; and
a temperature regulation and control system in communication with the heating and cooling system and providing control thereof.

18. The system of claim 17, wherein the thermal elements comprise:
a thermoelectric cooling element; and
a far infrared heating element.

19. The system of claim 17, wherein the thermal elements comprise:
a plurality of thermoelectric cooling elements sized and spaced to provide a desired temperature profile with respect to a surface of the cushioning structure.

20. The system of claim 19, wherein the temperature profile comprises substantially uniform temperature regulation with respect to the surface.

21. The system of claim 19, wherein the temperature profile comprises a desired temperature gradient across the surface.

22. The system of claim 19, wherein the temperature profile comprises precise temperature regulation with respect to one or more areas of the surface.

23. The system of claim 17, wherein the thermal elements comprise:
a sheet like heating element sized and configured to provide a desired temperature profile with respect to a surface of the cushioning structure.

24. The system of claim 23, wherein the temperature profile comprises substantially uniform temperature regulation with respect to the surface.

25. The system of claim 23, wherein the temperature profile comprises a desired temperature gradient across the surface.

26. The system of claim 23, wherein the temperature profile comprises precise temperature regulation with respect to one or more areas of the surface.

27. The system of claim 17, wherein a thermal element of the thermal elements is removable from the cushion media to facilitate cleaning of the cushion media.

28. The system of claim 17, wherein the thermal elements and the cushioning structure are adapted to provide the temperature regulation by radiant heat transfer.

29. The system of claim 17, wherein the cushioning structure is comprised of a cushion media having a substantially uniform cross-sectional density and adapted to allow air to pass substantially unimpeded through the cushion media.

30. The system of claim 29, wherein the cushion media comprises a filament mesh.

31. The system of claim 30, wherein a material forming the filament mesh is impregnated with at least one of an antibacterial and an antimicrobial substance.

32. A system comprising:
a non-inflatable cushioning structure comprised of cushion media adapted to allow air to pass substantially unimpeded through the cushion media;
a heating and cooling system in communication with the cushioning structure and providing temperature regulation thereof, wherein at least one thermal element of the heating and cooling system is disposed external to the cushion media; and
a temperature regulation and control system in communication with the heating and cooling system and providing control thereof.

33. The system of claim 32, wherein the at least one thermal element comprises a cooling element in communication with the cushioning structure via a duct.

34. The system of claim 33, wherein the duct comprises:
a plurality of outlets providing temperature regulated air into the cushioning structure.

35. The system of claim 34, wherein the plurality of outlets are sized and positioned to provide a desired temperature profile with respect to a surface of the cushioning structure.

36. The system of claim 35, wherein the temperature profile comprises substantially uniform temperature regulation with respect to the surface.

37. The system of claim 35, wherein the temperature profile comprises a desired temperature gradient across the surface.

38. The system of claim 35, wherein the temperature profile comprises precise temperature regulation with respect to one or more areas of the surface.

39. The system of claim 33, wherein the cooling element comprises:
a thermoelectric cooling element.

40. The system of claim 33, wherein the cooling element comprises:
a cooling element of a host facility heating, ventilation, and air-conditioning plant.

41. The system of claim 40, wherein the cushioning structure is provided temperature regulation as a zone of the host facility heating, ventilation, and air-conditioning plant.

42. The system of claim 33, wherein the heating and cooling system further comprises:
at least one heating element disposed separately from the cooling element.

43. The system of claim 42, wherein the heating element is disposed under the cushioning structure.

44. The system of claim 42, wherein the heating element is disposed within the cushioning structure.

45. The system of claim 42, wherein the heating element comprises:
a far infrared heating element.

46. The system of claim 42, wherein the heating element comprise:
a sheet like heating element sized and configured to provide a desired temperature profile with respect to a surface of the cushioning structure.

47. The system of claim 46, wherein the temperature profile comprises substantially uniform temperature regulation with respect to the surface.

48. The system of claim 46, wherein the temperature profile comprises a desired temperature gradient across the surface.

49. The system of claim 46, wherein the temperature profile comprises precise temperature regulation with respect to one or more areas of the surface.

50. The system of claim 32, wherein the cushioning structure is comprised of a cushion media having a substantially uniform cross-sectional density.

51. The system of claim 32, wherein the cushion media comprises a filament mesh.

52. The system of claim 51, wherein a material forming the filament mesh is impregnated with at least one of an antibacterial and an antimicrobial substance.

53. A method comprising:
assembling a plurality of cushion media components into a cushioning structure, the cushion media components having predefined shapes adapted to cooperate to form the cushioning structure;
placing thermal elements of a heating and cooling system in communication with the cushioning structure; and
controlling the heating and cooling system to provide temperature regulation with respect to the cushioning structure.

54. The method of claim 53, wherein the placing thermal elements of the heating and cooling system in communication with the communication structure comprises:
disposing at least one element within a cushion media component of the plurality of cushion media components.

55. The method of claim 53, wherein the placing thermal elements of the heating and cooling system in communication with the communication structure comprises:
disposing at least one element beneath a cushion media component of the plurality of cushion media components.

56. The method of claim 53, wherein the placing thermal elements of the heating and cooling system in communication with the communication structure comprises:
disposing at least one element external to the cushioning structure and coupling a duct between the at least one element and a cushion media component of the plurality of cushion media components.

57. The method of claim 53, wherein the placing thermal elements of the heating and cooling system in communication with the communication structure comprises:
coupling a duct between a heating, ventilation, and air-conditioning plant of a host facility and a cushion media component of the plurality of cushion media components.

58. The method of claim 53, further comprising:
adjusting an orientation of at least one cushion media component of the plurality of cushion media components to provide a different configuration of the cushioning structure.

59. The method of claim 53, further comprising:
removing at least one cushion media component of the plurality of cushion media components from the cushioning structure; and
performing a cleaning process with respect to the at least one cushion media component.

60. A system comprising:
a solid state temperature control element providing heating and cooling operation;
a thermal sheet sized and shaped to provide temperature regulation with respect to a cushioning structure; and
a plurality of thermal conductors in communication with the solid state temperature control element and the thermal sheet.

61. The system of claim 60, wherein the thermal sheet comprises a thermal emission material providing high thermal conductivity.

62. The system of claim 61, wherein the thermal emission material provides far infra-red (FIR) heat energy emission.

63. The system of claim 60, wherein the cushioning structure comprises a mattress, the solid state temperature control element, the thermal sheet, and the plurality of thermal conductors being adapted to removably interface with the mattress and provide temperature regulation with respect to a user of the mattress.

64. The system of claim 63, wherein the mattress comprises a bedding mattress.

65. The system of claim 60, wherein the solid state temperature control element comprises a thermoelectric module.

66. The system of claim 60, wherein the solid state temperature control element comprises a plurality of thermoelectric modules.

67. The system of claim 60, wherein the thermal sheet comprises a carbon fiber sheet.

68. The system of claim 67, further comprising a protective sheet disposed to provide a moisture barrier for the thermal sheet, the protective sheet adapted to facilitate thermal transfer therethrough.

69. The system of claim 60, wherein the plurality of thermal conductors comprise carbon fiber wire.
